(19) United States
(12) Patent Application Publication
(10) Pub. No.: US 2016/0236699 A1
(43) Pub. Date: Aug. 18, 2016

(54) THREE-IN-ONE CONVERTIBLE HAND TRUCK

(71) Applicant: Wen-Fa Wang, Taichung City (TW)

(72) Inventor: Wen-Fa Wang, Taichung City (TW)

(21) Appl. No.: 14/622,937

(22) Filed: Feb. 16, 2015

(51) Int. Cl. B62B 3/02; B62B 1/12

(52) U.S. Cl. CPC B62B 3/02; B62B 1/12

(57) ABSTRACT

A convertible hand truck includes a primary frame, a secondary frame and a linkage member. The primary frame has a hook member and a pair of wheels rotatably mounted thereon. The secondary frame has at least one caster rotatably mounted thereon. The linkage member has one end pivotally joined to the primary frame, and the other end pivotally joined to the secondary frame. In particular, the primary frame is movable into (a) a hand-truck position, generally parallel to the secondary frame, (b) a reclined-cart-position, generally positioned at a predetermined angle with respect to the secondary frame, and (c) a platform-cart position, generally perpendicular to the secondary frame. And while the primary frame is in the reclined-cart-position or the platform-cart position, the hook member of the primary frame secures the primary frame to the secondary frame, and the pair of wheels of the primary frame cooperates with the caster of the secondary frame to support the primary frame.

### BACKGROUND OF THE INVENTION

1. Field of the Invention

The present invention relates to a hand truck, and more particularly to a convertible hand truck that is convertible to a two-wheeled hand-truck, a reclined load-assist cart and a four-wheeled platform cart.

2. Description of the Related Art

Hand trucks have been developed over the years to aid people in the movement and transportation of items that otherwise would be too heavy or unwieldy to move. The ease of use of hand trucks makes the hand truck an ideal tool for transporting heavy objects. The wide utilization of hand trucks has caused many manufacturers to research improvements in the design of the modem hand truck. Today, industrial quality hand trucks are produced that have frames made of sturdier, tougher materials to simplify transporting appliances that are too large for smaller sized hand trucks. Additionally, hand trucks have been developed that are convertible into a cart or into an inclined cart to simplify the carrying of some objects. Examples of such hand truck may be found in U.S. Pat. No. 8,100,430 or in U.S. Pat. No. 6,364,328, in which a multi-mode hand truck is convertible to assume a hand-truck mode, a reclined load-assist mode, and a push-cart mode.

### SUMMARY OF THE INVENTION

It is an object of the present invention to provide a new style of convertible hand truck that can be easily converted from a two-wheeled hand truck to either a reclined load-assist cart or a four-wheeled platform cart in a quick manner.

Briefly described, the hand truck of this invention includes a primary frame, a secondary frame and a linkage member. The primary frame has a hook member on a top end thereof and a pair of wheels rotatably mounted on a lower end thereof. The secondary frame has at least one caster rotatably mounted thereon. The linkage member has one end pivotally joined to the primary frame, and the other end pivotally joined to a lower end of the secondary frame. In particular, the primary frame is movable into (a) a hand-truck position, generally parallel to the secondary frame, (b) a reclined-cart-position, generally positioned at a predetermined angle with respect to the secondary frame, and (c) a platform-cart position, generally perpendicular to the secondary frame. While the primary frame is in either one of the reclined-cart-position and the platform-cart position, the hook member of the primary frame secures the primary frame to the secondary frame, and the pair of wheels of the primary frame cooperates with the caster of the secondary frame to support the primary frame.

Preferably, the secondary frame may include an elongated frame body having a pair of spaced, longitudinally extending rails and a cross bar extending between the pair of rails. When the primary frame is in the reclined-cart-position, the hook member of the primary frame is engaged with the cross bar of the secondary frame, thereby securing the primary frame to the secondary frame in the reclined-cart-position.

The secondary frame may further include a pair of brackets arranged on inner, opposed sides of the pair of the rails and arranged in a line generally parallel to the cross bar such that when the primary frame is in the platform-cart-position, the hook member of the primary frame is held in position by the pair of brackets, thereby securing the primary frame to the secondary frame in the platform-cart-position.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1A is a front perspective view of a convertible hand truck in accordance with the preferred embodiment of the present invention;

FIG. 1B is a rear perspective view of the hand truck shown in FIG. 1A;

FIG. 2A is a front perspective view of the hand truck shown in FIG. 1A in a reclined-cart position;

FIG. 2B is a rear view of the hand truck shown in FIG. 2A;

FIG. 3A is a perspective view of the hand truck shown in FIG. 1A in a platform-cart position;

FIG. 3B is another perspective view of the hand truck shown in FIG. 3A;

FIG. 3C is a partially perspective view of another hand truck with a pair of modified brackets for supporting a primary frame;

FIG. 3D is a view similar to FIG. 3C, illustrating that the primary frame is engaged with the modified brackets;

FIG. 4A is a partial enlarged view of the hand truck shown in FIG. 2A;

FIG. 4B is a cross section taken along the line IV-IV in FIG. 4A;

FIG. 5A is a partial enlarged view of the hand truck shown in FIG. 1B, taken from another angle, showing a frame locking mechanism of the hand truck in a locked position;

FIG. 5B is a view similar to FIG. 5A, showing the frame locking mechanism in an unlocking position;

FIG. 6A is a partial enlarged view of the hand truck shown in FIG. 1A, showing a toe locking mechanism of the hand truck in a locked position;

FIG. 6B is a cross section taken along the line VI-VI in FIG. 6A;

FIG. 7A is partial enlarged view of the hand truck shown in FIG. 1A, taken from another angle, showing that a linkage locking mechanism of the hand truck is in a locking position.

FIG. 7B is a view similar to FIG. 7A, showing that the linkage locking mechanism is in a released position.

FIG. 8 is a side elevational view of the hand truck shown in FIG. 1A in an upright hand-truck position;

FIG. 9 is a side elevational view of the hand truck shown in FIG. 1A being in transition to a four-wheeled cart;

FIG. 10 is a side elevational view of the hand truck shown in FIG. 1A, in a reclined cart position;

FIG. 11 is a side elevational view of the hand truck shown in FIG. 1A in a platform cart position; and

FIG. 12 is a view similar to FIG. 11, except that a toe plate extension of the hand truck is in a raised, extended position.

### DETAILED DESCRIPTION OF EMBODIMENTS

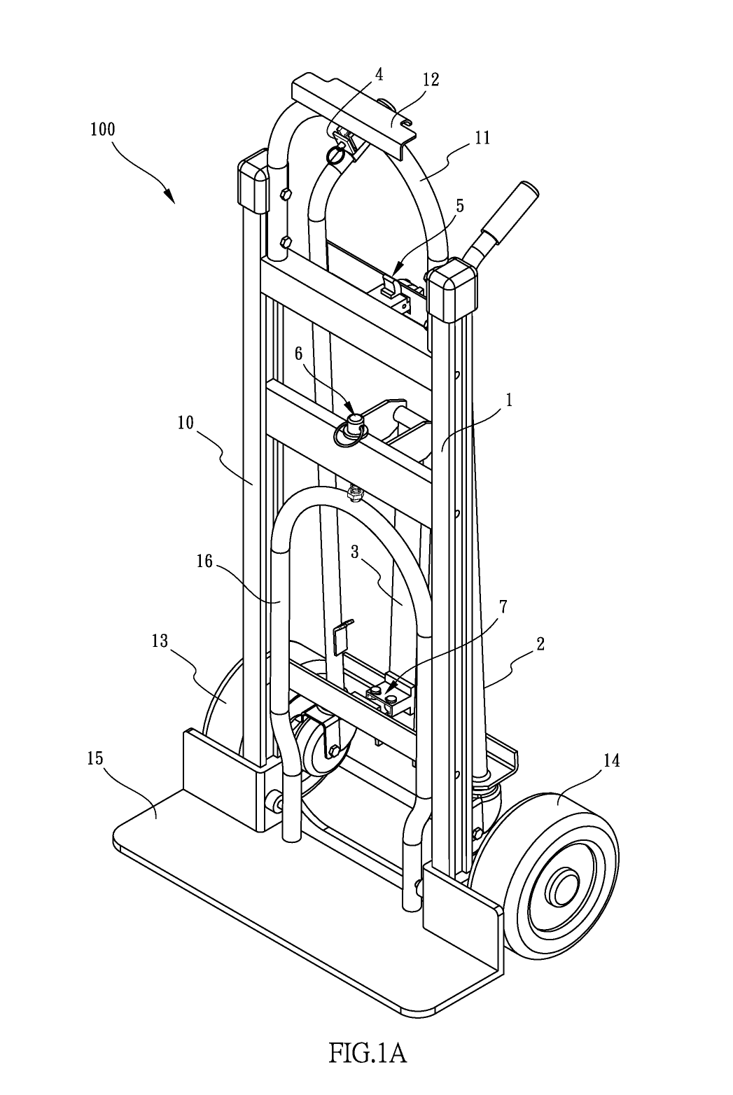

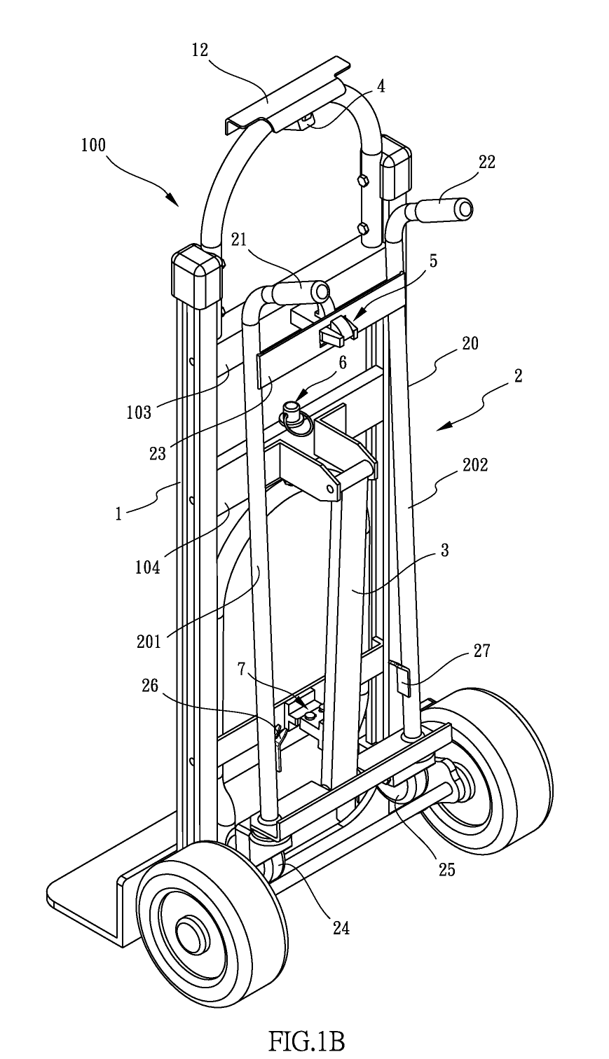

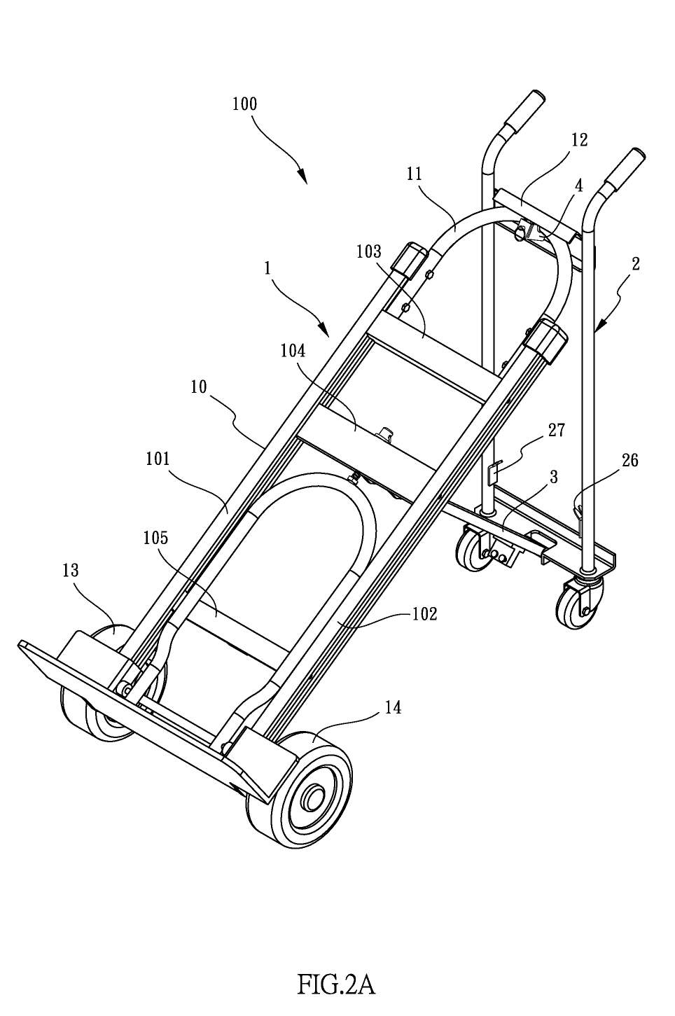

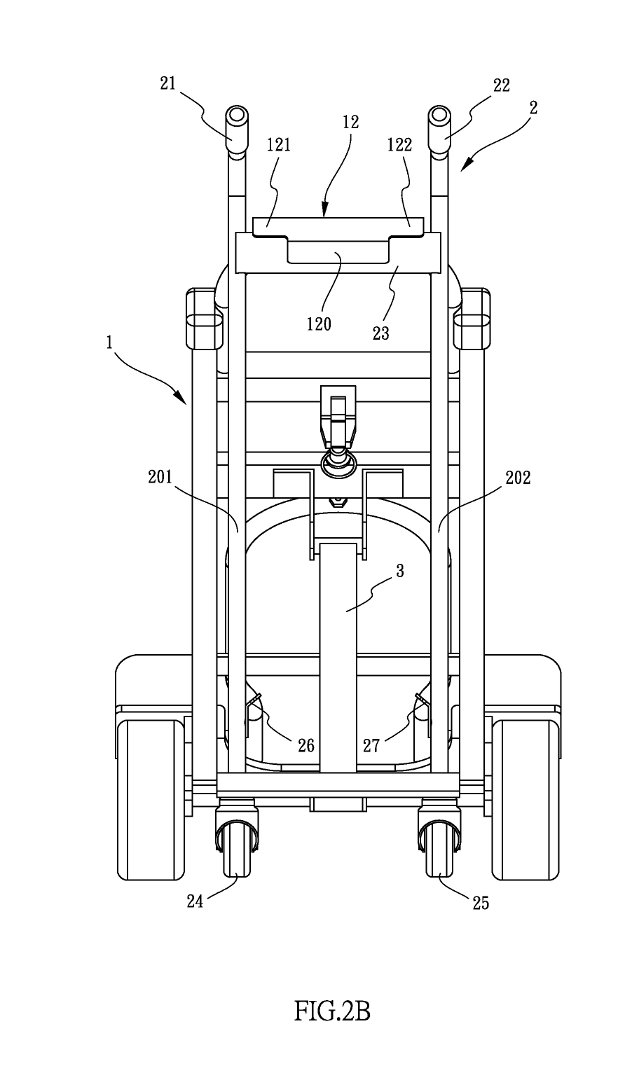

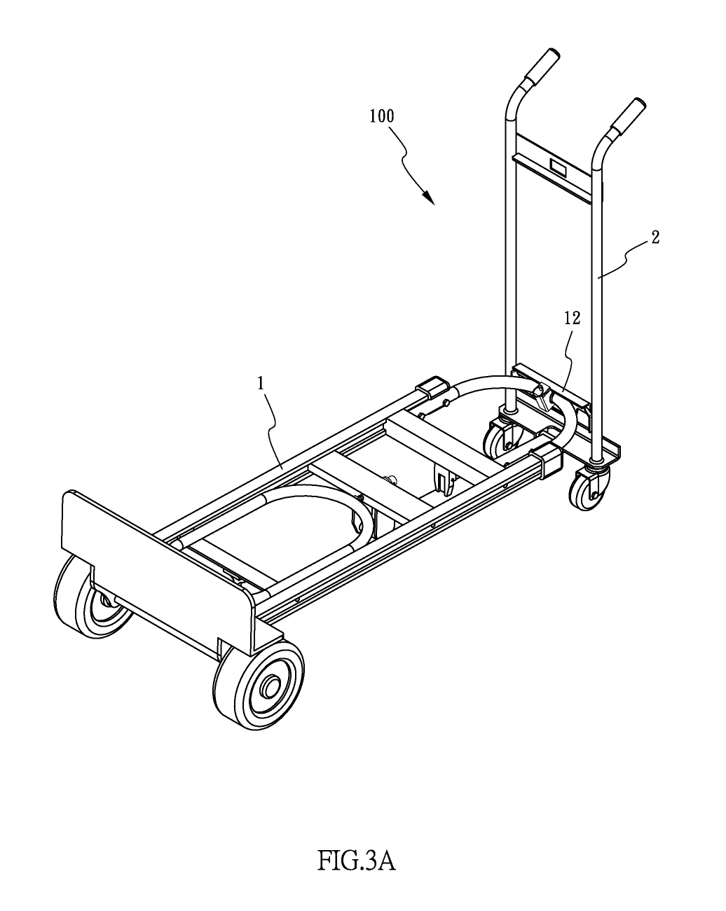

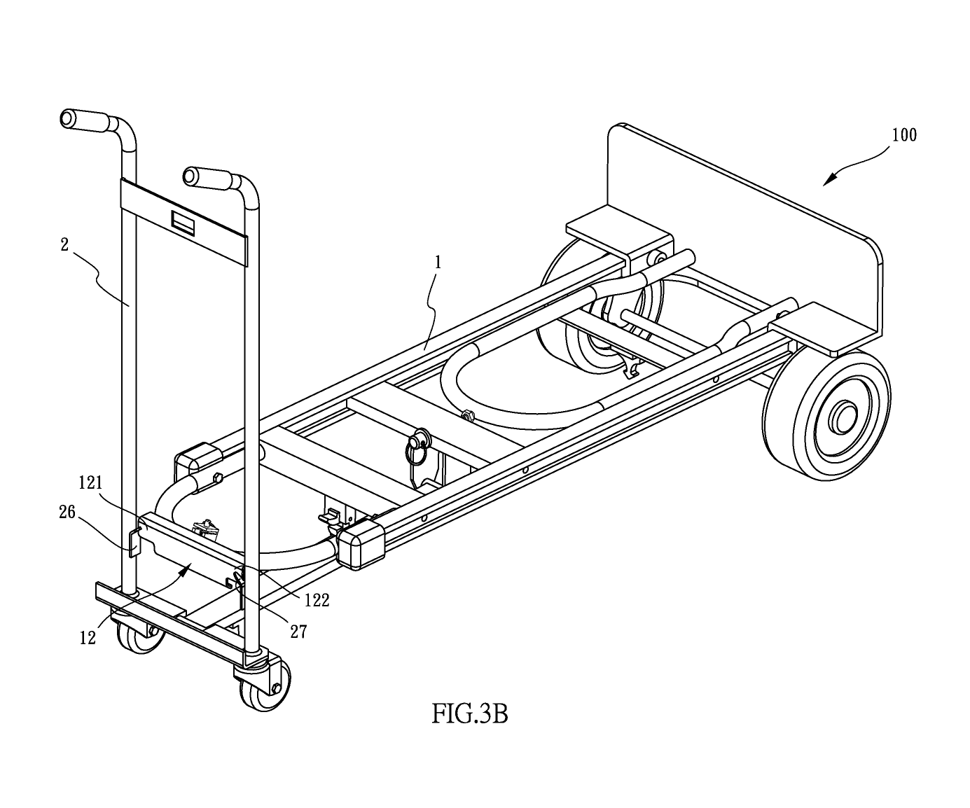

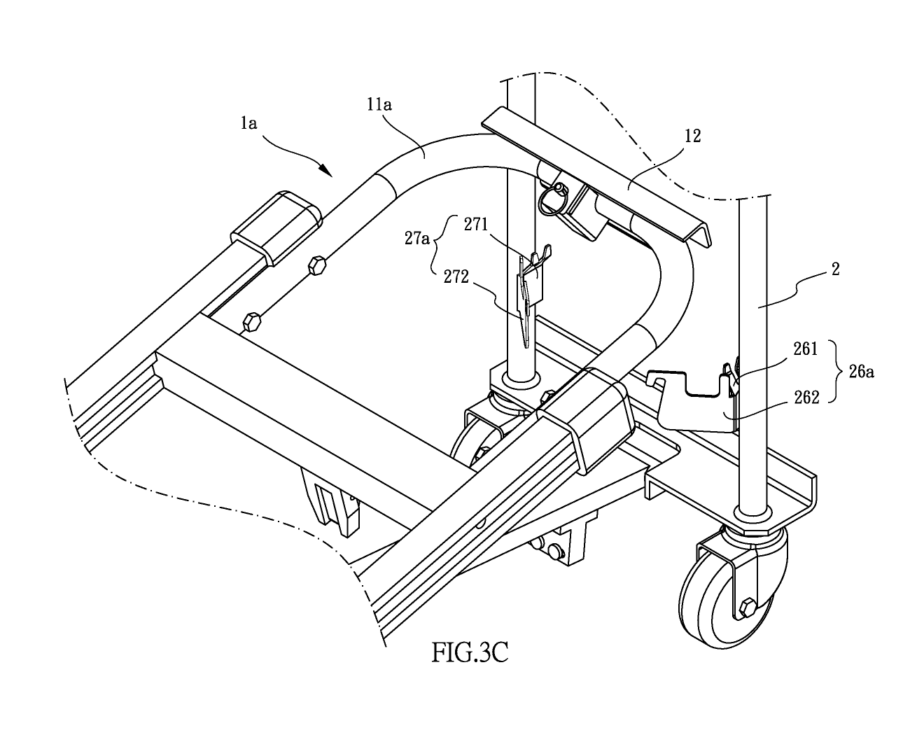

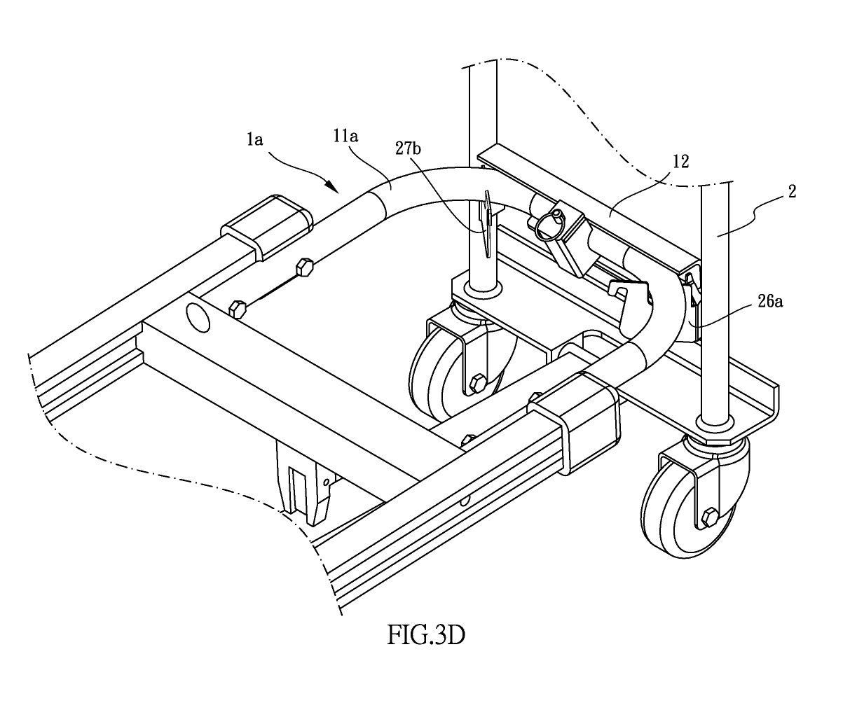

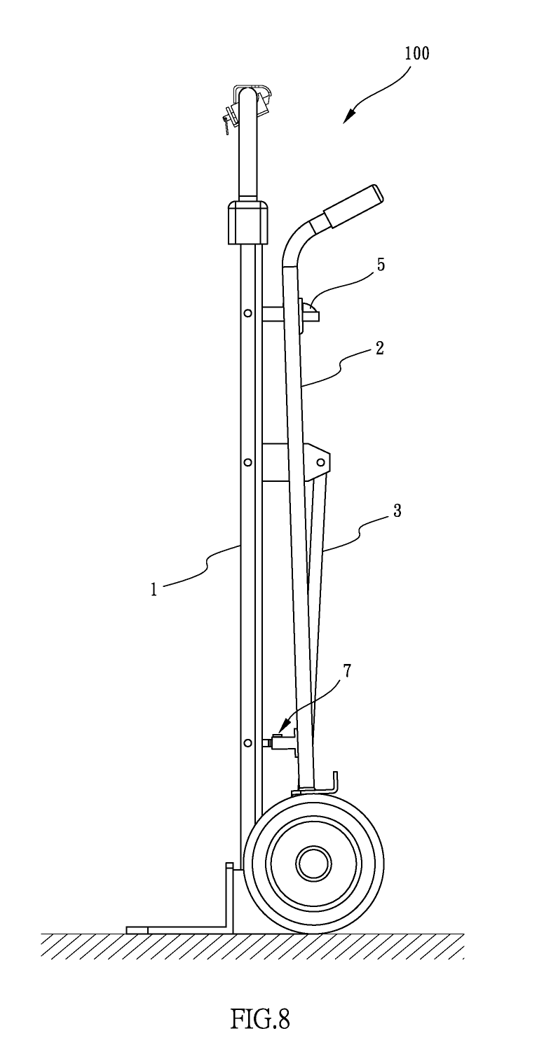

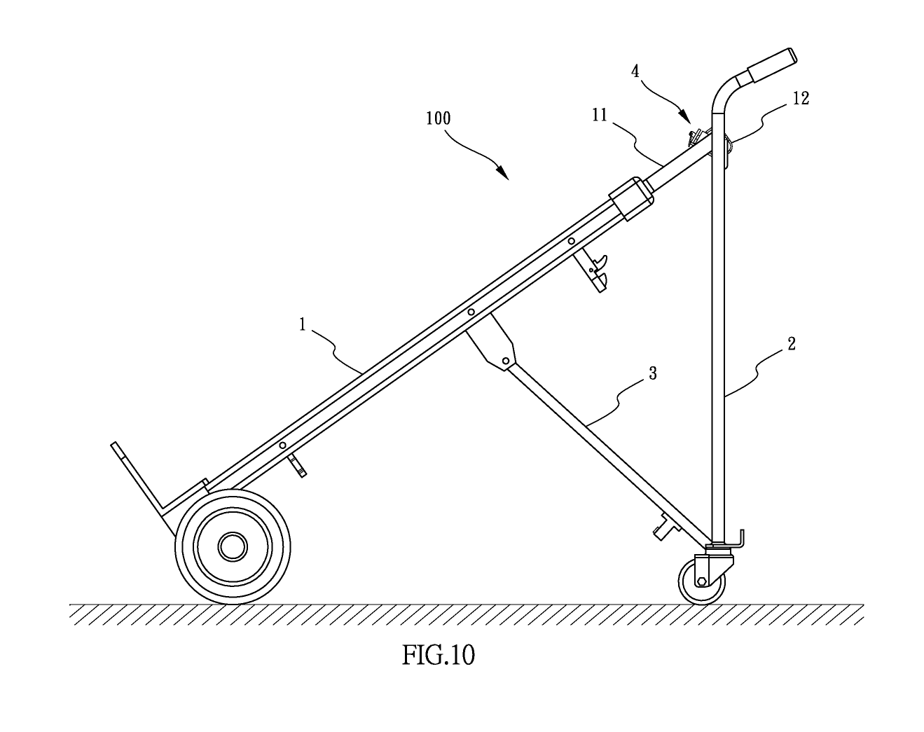

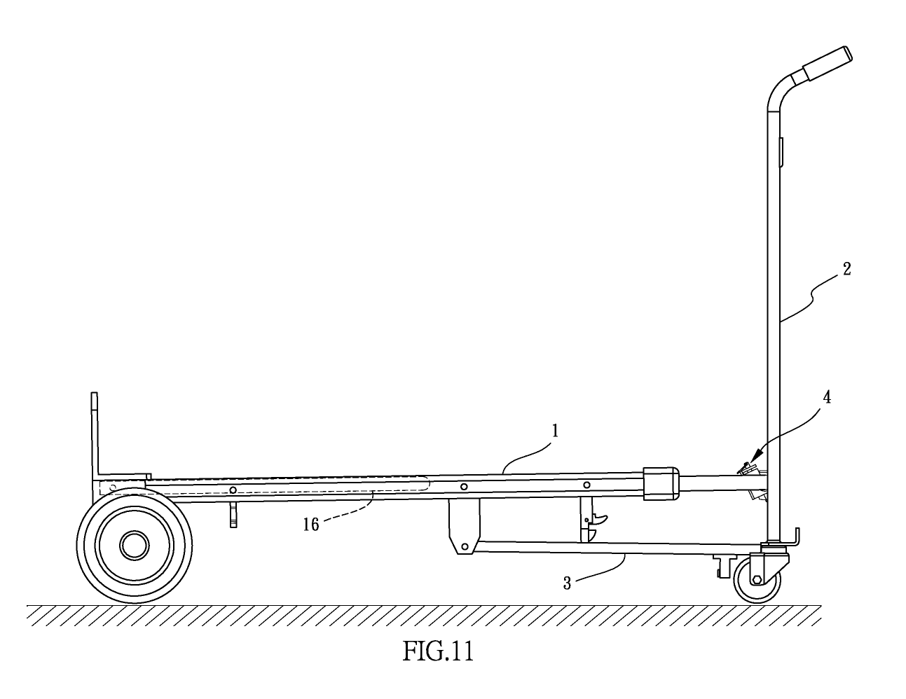

Referring to the drawings in detail, there is shown in FIGS. 1-12 a preferred embodiment of a hand truck, generally designated 100 in accordance with a preferred embodiment of the invention. Generally speaking, the hand truck 100 is convertible from a two-wheeled hand truck (shown in FIGS. 1A and 8) into either one of a reclined cart (shown in FIGS. 2A and 10) and a platform cart (shown in FIGS. 3A and 11). To this end, the hand truck 100 generally includes a primary frame 1, a secondary frame 2 and a linkage member 3 between the primary frame 1 and the secondary frame 2, as shown in FIG. 1B or 2A.

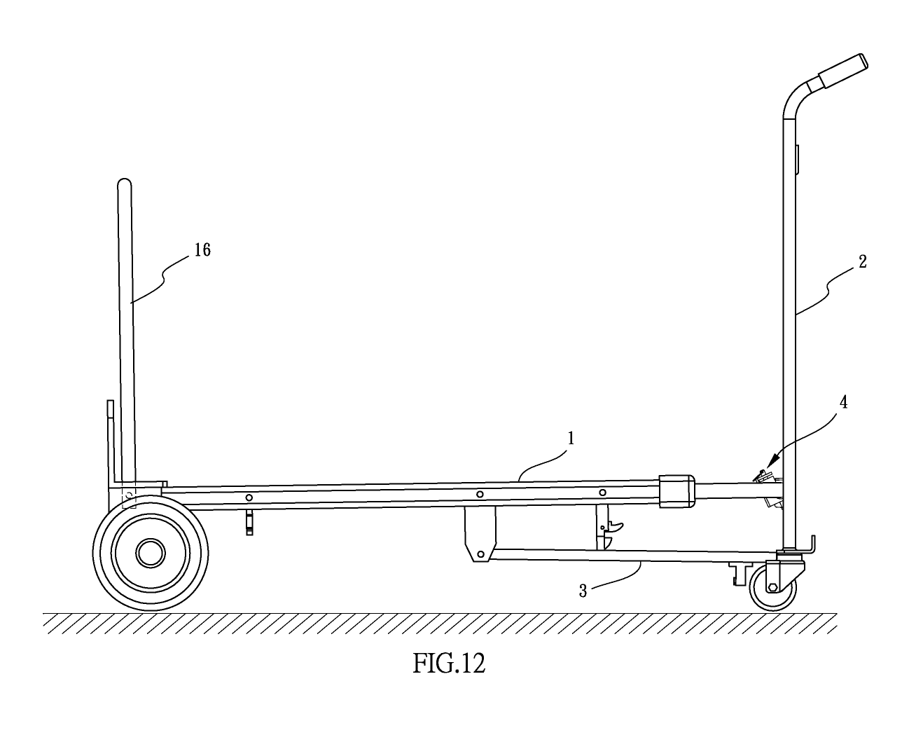

Referring in FIG. 1, the primary frame 1 includes an elongated frame body 10, a generally U-shaped head portion 11 extending from an upper end of the frame body 10, a hook member 12 is provided on the head portion 11, a pair of wheels 13, 14 rotatably mounted on a lower end of the frame body 10, a toe plate shelf 15 secured onto the lower end of the frame body 10 opposite the pair of wheels 12, 13, and a generally U-shaped toe plate extension 16 generally located proximate to the toe plate shelf 15. As best seen in FIG. 2A, the frame body 10 of the primary frame 1 has a pair of spaced, longitudinally extending rails 101, 102, three cross bars 103, 104, 105 extending between the pair of rails 101, 102 and spaced from one another. The toe plate extension 16 is pivotable between a retracted position (as shown in FIG. 2A or 11), generally parallel to the rails 101, 102, and an extended position (as shown in FIG. 12), generally perpendicular to the rails 101, 102.

As best seen in FIG. 1B or 2B, the secondary frame 2 includes an elongated frame body 20 having a pair of spaced, longitudinally extending rails 201, 202. The secondary frame 2 further includes a pair of hand grips 21, 22 extending from an upper end of the pair of rails 201, 202, a cross bar 23 extending between the pair of rails 201, 202, a pair of casters 24, 25 rotatably mounted a lower end of the pair of rails 201, 202, and a pair of fork-shaped brackets 26, 27 formed on inner, opposed sides of the pair of the rails 201, 202 and arranged in a line generally parallel to the cross bar 23.

As shown in FIG. 2A, the linkage member 3 has one end pivotally joined to the middle cross bar 104 of the frame body 10 of the primary frame 1, and the other end pivotally joined to a lower end of the secondary frame 2.

The primary frame 1 is capable of moving into (a). a first, hand-truck position, generally parallel to the secondary frame (as depicted in FIGS. 1A, 1B and 8); (b). a second, reclined-cart-position, generally positioned at a predetermined angle with respect to the secondary frame 2 (as depicted in FIGS. 2A, 2B and 10); and (c). a third, platform-cart position, generally perpendicular to the secondary frame 2 (as depicted in FIGS. 3A, 3B, 11 and 12). While the primary frame 1 is in either one of the reclined-cart-position or the platform-cart-position, the pair of wheels 13, 14 of the primary frame 1 cooperates with the casters 24, 25 of the secondary frame 2 to support the primary frame 1, as illustrated in FIG. 2A or 3A.

Furthermore, while the primary frame 1 is in the reclined-cart-position, as shown in FIG. 2A, the hook member 12 of the primary frame 1 is engaged with the cross bar 23 of the secondary frame 2, thereby securing the primary frame 1 to the secondary frame 2 in the reclined-cart-position. Similarly, while the primary frame 1 is in the platform-cart position, as best seen in FIG. 3B, the hook member 12 of the primary frame 1 is held in position by the pair of brackets 26, 27 of the secondary frame 2, thereby securing the primary frame 1 to the secondary frame 2 in the platform-cart-position.

In the illustrated embodiment, the pair of brackets 26, 27 are shown mounted at the opposed sides of the pair of the rails 201, 202. However, it will be appreciated that other pair of bracket configurations could be utilized. For example, the brackets 26a, 27a, as shown in FIGS. 3C and 3D, may be utilized to support not only the hook member 12 with their fork-shaped portions 261, 271 but also a modified head portion 11a of a primary frame 1a with their hook portions 262, 272 extending from the fork-shaped portions 261, 271 respectively.

Referring back to FIGS. 2B and 3B, the hook member 12 of the primary frame 1 has a curved tongue portion 120 and a pair of enlarged shoulders 121, 122 extending from opposite sides of the tongue portion 120. When the primary frame 1 is in the reclined-cart-position, as shown in FIGS. 2A and 2B, the tongue portion 120 of the hook member 12 of the primary frame 1 is engaged with the cross bar 23 of the secondary frame 2. When the primary frame 1 is in the platform-cart position, as shown in FIGS. 3A and 3B, the pair of shoulders 121, 122 of the hook member 12 of the primary frame 1 is supported and positioned by the pair of brackets 26, 27 of the secondary frame 2.

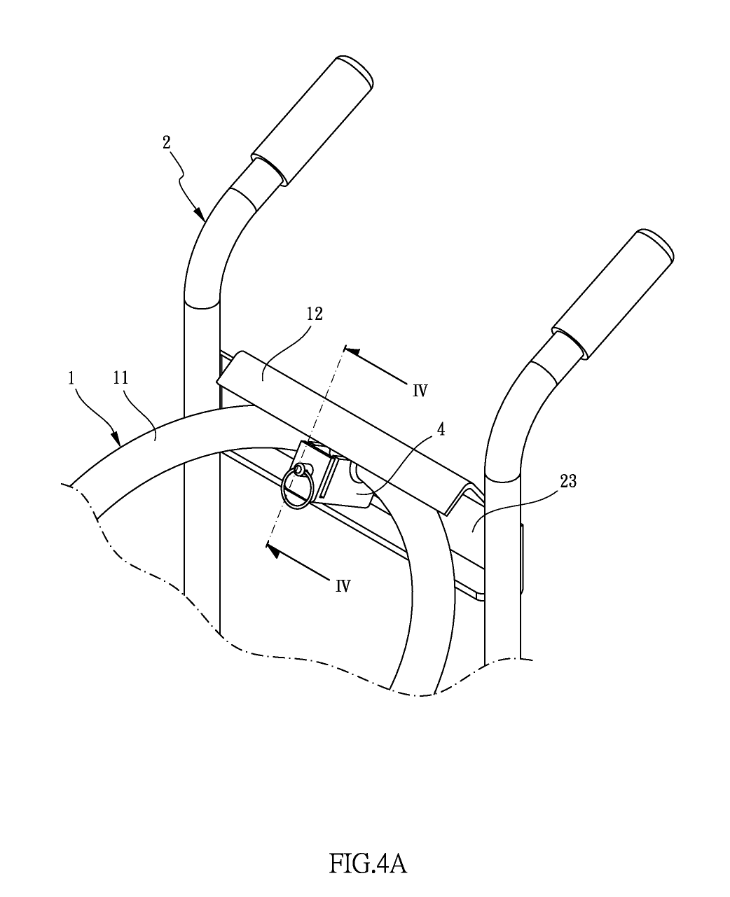

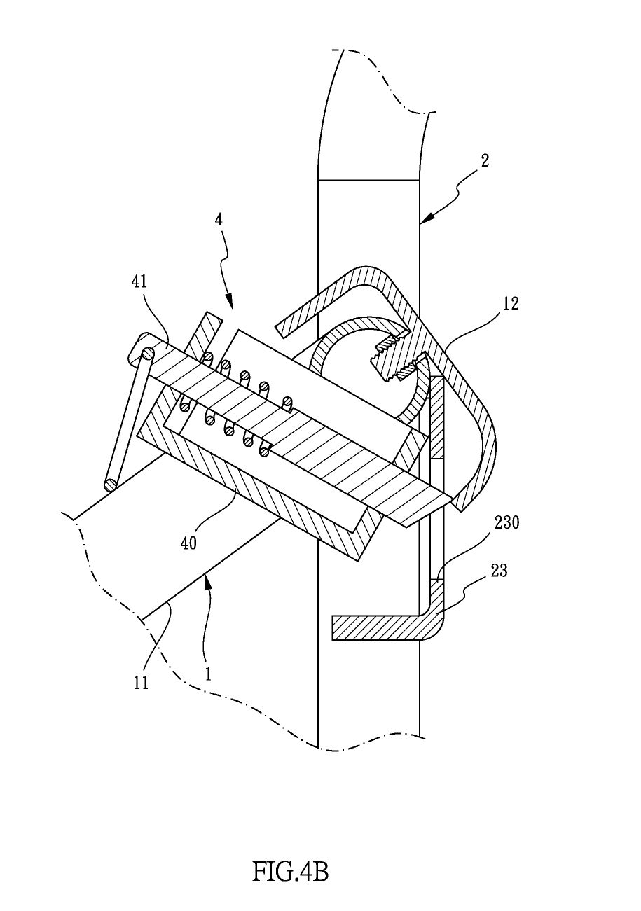

Referring back to FIG. 1A, the hand truck 100 further includes from top to bottom a hook locking mechanism 4, a frame locking mechanism 5, a toe locking mechanism 6 and a linkage locking mechanism 7. Briefly, the hook locking mechanism 4 is provided to lock the primary frame 1 in the reclined-cart-position, as depicted in FIGS. 2A and 4A. The frame locking mechanism 5 and the linkage locking mechanism 7 together are provided to ensure that the secondary frame 2 will not undesirably departs from the primary frame 1 while the hand truck 100 serves as the upright two-wheeled hand truck, as shown in FIG. 1B. As for the toe locking mechanism 6, it is provided to lock the toe plate extension 16 in the retracted position, as best seen in FIGS. lA and 6A.

As shown in FIG. 4A, the hook locking mechanism 4 is disposed on the head portion 11 of the primary frame 1 and is operable to allow or disallow the hook member 12 to be disengaged from the cross bar 23 of the secondary frame 2, thereby locking or unlocking the primary frame 1 in the reclined-cart-position. More specifically, the hook locking mechanism 4 includes a casing 40 and a spring-loaded bolt 41 extending through the casing 40 from front to rear. The spring-loaded bolt 41 is normally inserted in a positioning hole 230 defined in the cross bar 23 of the secondary frame 2 for locking the primary frame 1 in the reclined-cart-position. To release the primary frame 1 from the reclined-cart-position, the spring-loaded bolt 41 be pulled out with respect to the casing 40 to be withdrawn from the positioning hole 230 of the cross bar 23 of the secondary frame 2.

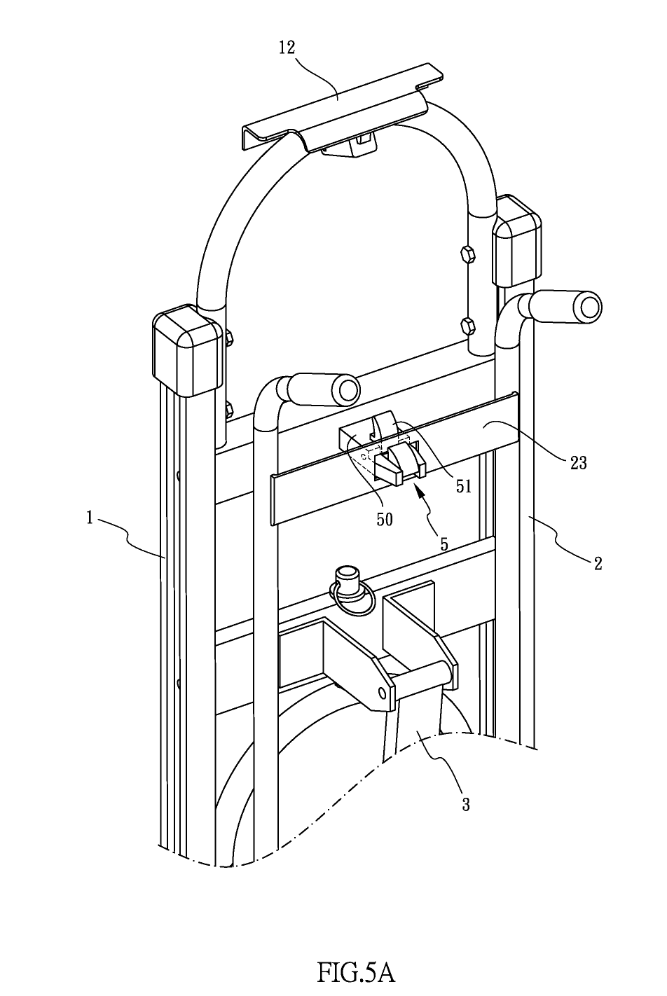

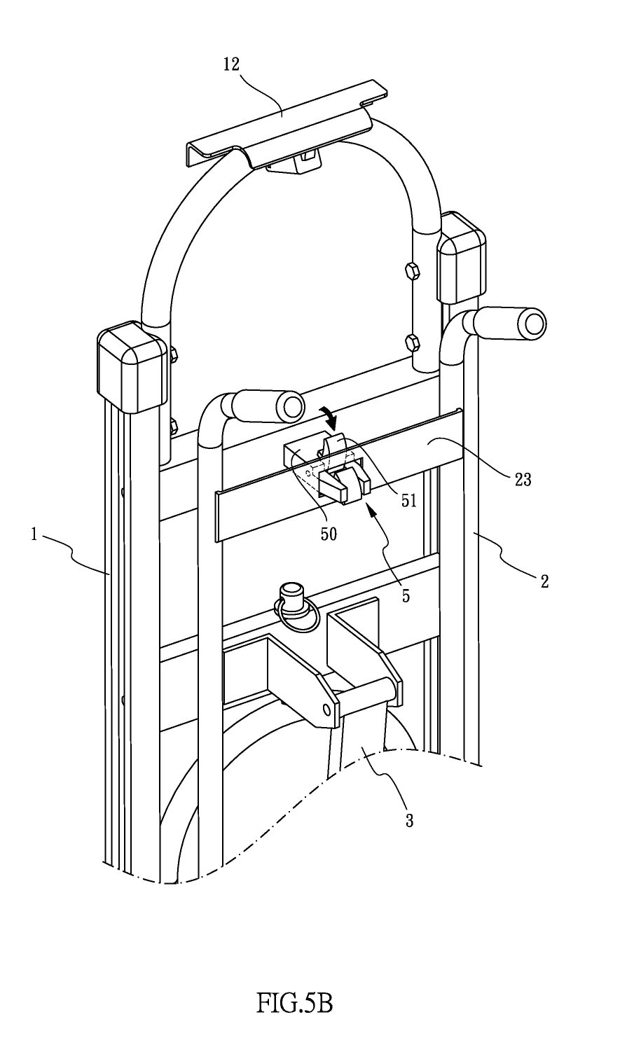

Referring to FIG. 1B, the frame locking mechanism 5 is disposed on the upper cross bar 103 of the frame body 10 of the primary frame 1 for locking the primary frame 1 and the secondary frame 2 together. More specifically, as shown in FIG. 5A, the frame locking mechanism 5 includes a pivot bracket 50 and a latch arm 51 pivotably mounted on the pivot bracket 50. While the primary frame 1 is in the hand-truck position, the cross bar 23 may be hooked on the latch arm 51 with the positioning hole 230, as shown in FIG. 5A. To release the cross bar 23, the latch arm 51 may be pivoted down, as indicated by the arrow in FIG. 5B, so that the upper portion of the secondary frame 2 may be detached from the primary frame 1.

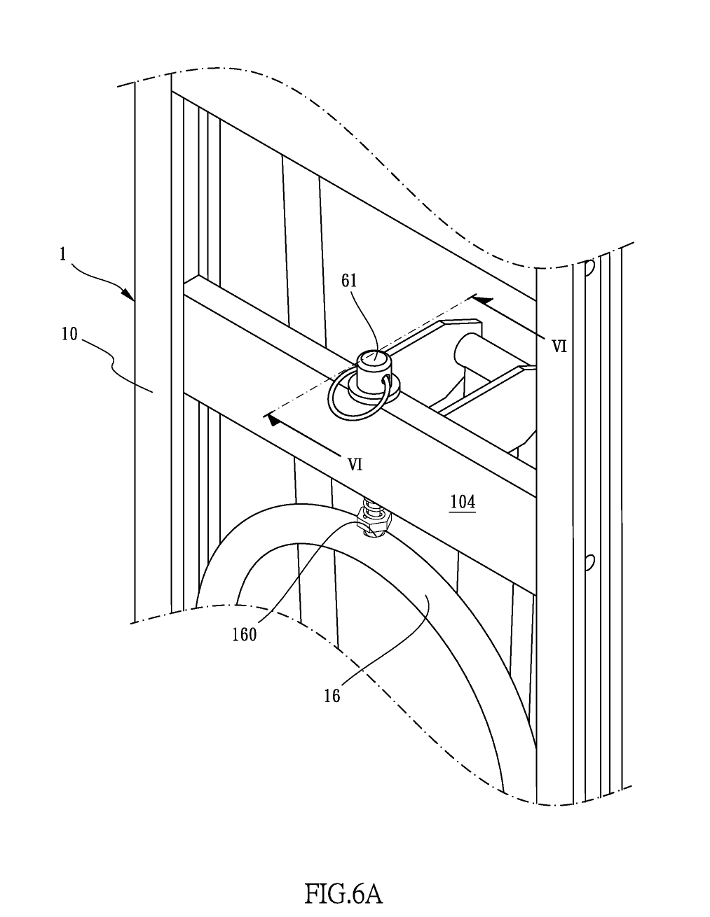

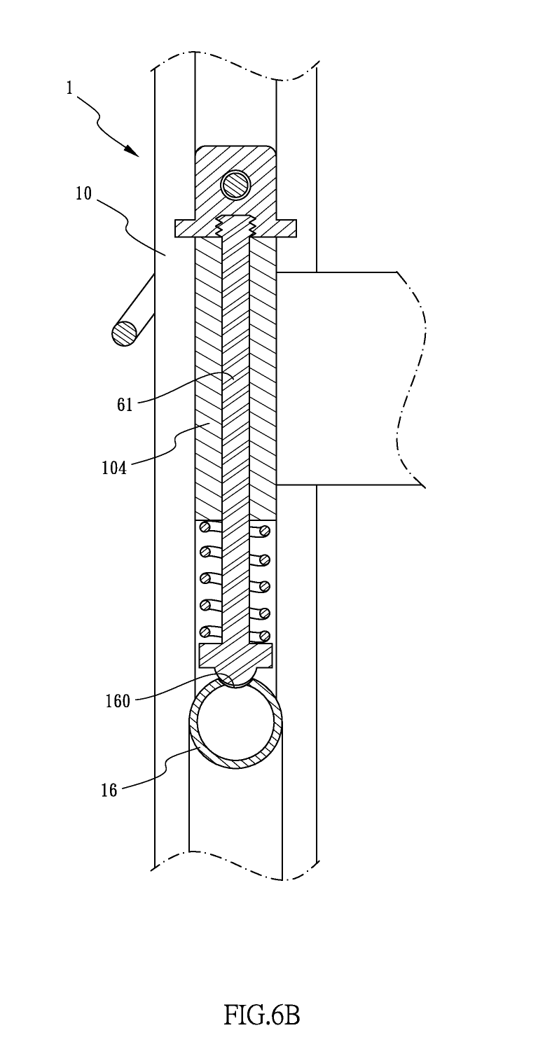

Referring to FIG. 6A, the toe locking mechanism 6 disposed on the middle cross bar 104 of the frame body 10 of the primary frame 1 and is operable to lock or unlock the toe plate extension 16 in the retracted position. As shown in FIG. 6B, the toe locking mechanism 6 includes a spring-loaded bolt 61 extending through the middle cross bar 104 of the frame body 10 of the primary frame 1 from top to bottom and is operable to either be inserted in or withdrawn from a positioning hole 160 defined in the toe plate extension 16 for locking or unlocking the toe plate extension 16 in the retracted position.

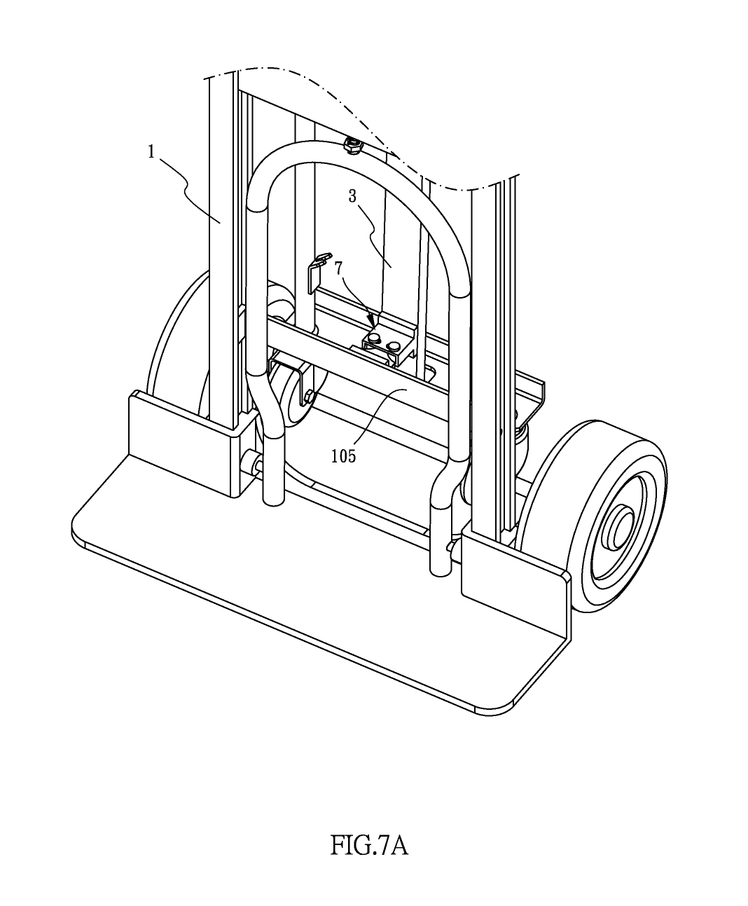

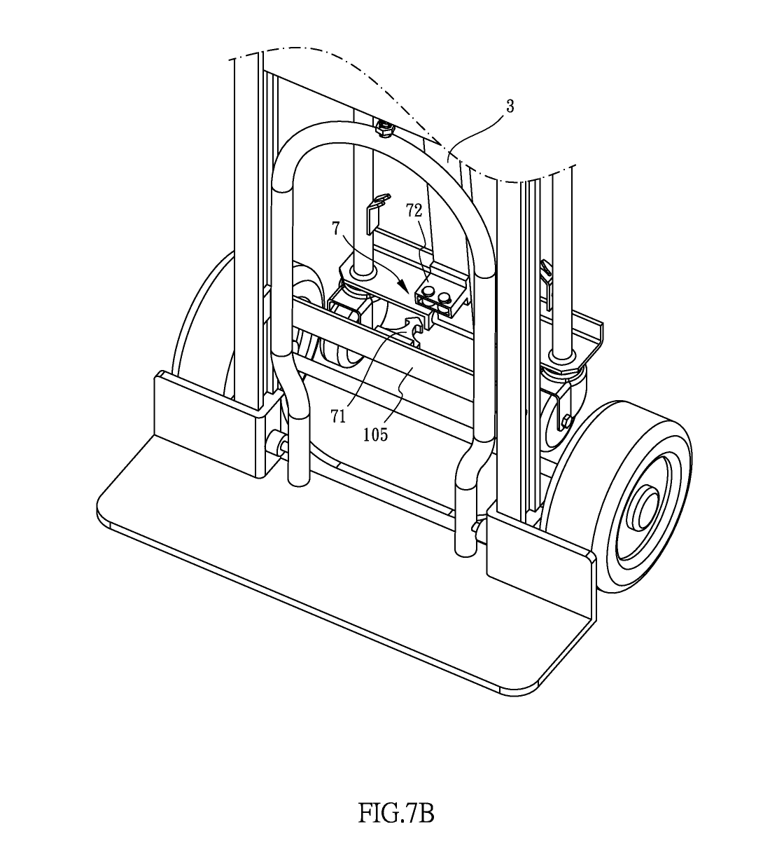

Referring to FIG. 7A, the linkage locking mechanism 7 is at least partly disposed on the lower cross bar 105 of the frame body 10 of the primary frame 1 for locking primary frame 1 and the linkage member 3 together. More specifically, as best seen in FIG. 7B, the linkage locking mechanism 7 includes a male snap member 71 disposed on the lower cross bar 105 of the primary frame 1, and a female snap member 70 disposed on the linkage member 3 to be engaged with the male snap member 71.

FIGS. 8-12 illustrates a process of converting the hand truck 100 (as shown in FIG. 8) into a reclined cart (as shown in FIG. 10), and to a platform cart (as shown in FIG. 11), and finally to the platform cart with the toe plate extension 16 stand upright for shielding articles (not shown) to be carried thereon (as shown in FIG. 12).

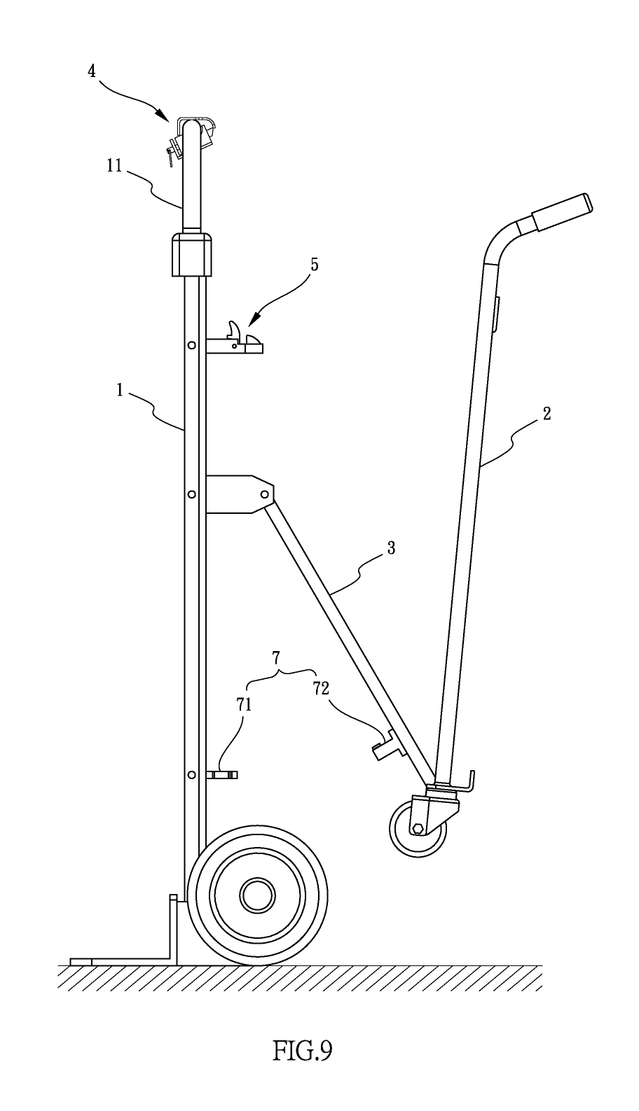

As shown in FIG. 8, the hand truck 100 serves as a two-wheeled hand truck. At this time, it is noted that the frame locking mechanism 5 and the linkage locking mechanism 7 are preferable to both be in a locking state in order to ensure that the secondary frame 2 is not movable with respect to the primary frame 1. Thus, as shown in FIG. 9, the secondary frame 2 is firstly detached from the primary frame 1 by unlocking the frame locking mechanism 5 as well as the linkage locking mechanism 7. Then, the head portion 11 of the primary frame 1 may be rested on the cross bar 23 of the secondary frame 2 by the hook member 12, as shown in FIG. 10. Preferably, the spring-loaded bolt 41 of the hook locking mechanism 4 is operated to be inserted in the positioning hole 230 of the cross bar 23 to ensure that the head portion 11 of the primary frame 1 is locked onto the cross bar 23 of the secondary frame 2, as illustrated in FIG. 4B. Afterwards, the spring-loaded bolt 41 may be withdrawn from the positioning hole 230 of the cross bar 23 to release the primary frame 1 from the secondary frame 1. Next, the head portion 11 of the primary frame 1 may be pivoted downward and finally rested on the pair of brackets 26, 27 of the secondary frame 2, as shown in FIGS. 11 and 3B. If necessary, the toe plate extension 16 may also be pivoted up, as shown in FIG. 12, to provide extra protection.

What is claimed is:

1. A convertible hand truck, comprising:
a primary frame having a hook member on a top end thereof and a pair of wheels rotatably mounted on a lower end thereof;
a secondary frame having at least one caster rotatably mounted thereon; and
a linkage member having one end pivotally joined to the primary frame, and the other end pivotally joined to a lower end of the secondary frame;
wherein the primary frame is movable into (a) a hand-truck position, generally parallel to the secondary frame, (b) a reclined-cart-position, generally positioned at a predetermined angle with respect to the secondary frame, and (c) a platform-cart position, generally perpendicular to the secondary frame; and while the primary frame is in either one of the reclined-cart-position and the platform-cart position, the hook member of the primary frame secures the primary frame to the secondary frame, and the pair of wheels of the primary frame cooperates with the caster of the secondary frame to support the primary frame.

2. A convertible hand truck as recited in claim 1, wherein the primary frame includes an elongated frame body, and a generally U-shaped head portion extending from an upper end of the frame body, on which the hook member of the primary frame is disposed.

3. A convertible hand truck as recited in claim 1, wherein the secondary frame includes an elongated frame body having a pair of spaced, longitudinally extending rails and a cross bar extending between the pair of rails; and when the primary frame is in the reclined-cart-position, the hook member of the primary frame is engaged with the cross bar of the secondary frame, thereby securing the primary frame to the secondary frame in the reclined-cart-position.

4. A convertible hand truck as recited in claim 3, wherein the secondary frame further includes a pair of brackets arranged on inner, opposed sides of the pair of the rails and arranged in a line generally parallel to the cross bar such that when the primary frame is in the platform-cart-position, the hook member of the primary frame is held in position by the pair of brackets, thereby securing the primary frame to the secondary frame in the platform-cart-position.

5. A convertible hand truck as recited in claim 4, wherein the hook member of the primary frame has a curved tongue portion and a pair of enlarged shoulders extending from opposite sides of the tongue portion;
when the primary frame is in the reclined-cart-position, the tongue portion of the hook member of the primary frame is engaged with the cross bar of the secondary frame; and when the primary frame is in the platform-cart position, the pair of shoulders of the hook member of the primary frame is supported by the pair of brackets of the secondary frame.

6. A convertible hand truck as recited in claim 5, wherein each of brackets has a fork shape.

7. A convertible hand truck as recited in claim 2, further comprising a hook locking mechanism disposed on the head portion of the primary frame and being operable to allow or disallow the hook member to be disengaged from the cross bar of the secondary frame, thereby locking or unlocking the primary frame in the reclined-cart-position.

8. A convertible hand truck as recited in claim 7, wherein the hook locking mechanism includes a casing, and a spring-loaded bolt extending through the casing from front to rear and being operable to either be inserted in or withdrawn from a positioning hole defined in the cross bar of the secondary frame for locking or unlocking the primary frame in the reclined-cart-position.

9. A convertible hand truck as recited in claim 1, wherein the primary frame includes an elongated frame body having a pair of spaced, longitudinally extending rails and a cross bar extending between the pair of rails, and the primary frame further includes a toe plate shelf coupled to a lower end of the frame body.

10. A convertible hand truck as recited in claim 9, wherein the primary frame further includes a generally U-shaped toe plate extension coupled to the lower end of the frame body; and the toe plate extension is pivotable between a retracted position, generally parallel to the rails of the frame body, and an extended position, generally perpendicular to the rails of the frame body.

11. A convertible hand truck as recited in claim 10, further comprising a toe locking mechanism disposed on the cross bar of the frame body of the primary frame and being operable to lock or unlock the toe plate extension in the retracted position.

12. A convertible hand truck as recited in claim 11, wherein the toe locking mechanism includes a spring-loaded bolt extending through the cross bar of the frame body of the primary frame from top to bottom and being operable to either be inserted in or withdrawn from a positioning hole defined in the toe plate extension for locking or unlocking the toe plate extension in the retracted position.

13. A convertible hand truck as recited in claim 1, wherein the primary frame includes an elongated frame body having a pair of spaced, longitudinally extending rails, and three cross bars extending between the pair of rails; the convertible hand truck further comprises a frame locking mechanism disposed on an upper one of the three cross bars for locking or unlocking the secondary frame on or from the primary frame, and a linkage locking mechanism at least partly disposed on a lower one of the three cross bars for locking or unlocking the linkage member on or from the primary frame; and the linkage member is pivoted onto a middle one of the three cross bars.

14. A convertible hand truck as recited in claim 13, wherein the frame locking mechanism includes a pivot bracket and a latch arm pivotably mounted on the pivot bracket; and the cross bar of the secondary frame defines a positioning hole therein such that while the primary frame is in the hand-truck position, the cross bar is hooked on the latch arm with the positioning hole for locking the secondary frame to the primary frame.

15. A convertible hand truck as recited in claim 14, further comprising a hook locking mechanism including a casing, and a spring-loaded bolt extending through the casing from front to rear and being operable to either be inserted in or withdrawn from the positioning hole of the cross bar of the secondary frame for locking or unlocking the primary frame in the reclined-cart-position.

16. A convertible hand truck as recited in claim 13, wherein the linkage locking mechanism includes a male snap member disposed on the lower cross bar of the primary frame, and a female snap member disposed on the linkage member to be engaged with the male snap member for locking the linkage member to the primary frame.

17. A convertible hand truck as recited in claim 13, wherein the secondary frame further includes a pair of hand grips mounted thereon.
